(19) United States
(12) Patent Application Publication
(10) Pub. No.: US 2017/0262421 A1
(43) Pub. Date: Sep. 14, 2017

(54) Form Autofilling System

(71) Applicant: KYOCERA Document Solutions Inc., Concord, CA (US)

(72) Inventor: Tommy Yue, Concord, CA (US)

(73) Assignee: Tommy Yue, Concord, CA (US)

(21) Appl. No.: 15/069,811

(22) Filed: Mar. 14, 2016

(51) Int. Cl. G06F 17/24; H04L 29/08

(52) U.S. Cl. CPC G06F 17/243; H04L 67/1074

(57) ABSTRACT

An autofill device directly connected with a client device over a peer to peer connection and to a server over a network connection, the autofill device being configured to load a form into memory and enter an autofill mode in which it receives a permission token from the client device, requests user data from the server using the permission token, receives the user data upon verification of the permission token by the server, and parses the received user data to automatically fill in one or more form fields in the form. The filled in form can be printed and/or electronically sent to a desired destination.

### BACKGROUND

Field of the Invention

The present disclosure relates to autofilling digital copies of forms, particularly a system for accessing remotely stored user data and using it to fill in form fields before printing and/or electronically sending a form.

Background

Companies and organizations often require individuals to fill out and submit forms to supervisors or departments. For example, an employee who goes on a business trip often needs to fill out a travel expense claim form, and submit it to a supervisor or an accounting department at their company in order to be reimbursed. Many forms are preformatted hard copies or digital documents such as PDF files, which require individuals to type or handwrite information into blank fields on the form.

Many forms, regardless of their type, include blank fields that ask users to enter the same types of basic information. For instance, although a tax form and a health benefit renewal form may be used for different purposes and may even be submitted to different departments, both forms may ask an individual to enter their name, employee identification number, social security number, department identification number, and other general information about the individual. Routinely filling in this type of information manually can become tedious for users.

Similarly, many users often need to submit the same form many different times, with only a few details varying each time. For example, an employee may need to fill out a monthly expense report form. Since information such as the employee's name, employee number, and department stay the same from month to month, it can be tedious or annoying for the employee to enter the same information into the same form every month.

What is needed is a system and method for retrieving information associated with a user from a database, and using that retrieved information for automatically filling in corresponding blank form fields on a selected form.

### SUMMARY

The present disclosure provides an autofill device comprising a peer to peer networking interface configured to establish a direct peer to peer connection with a client device, and a network interface configured to establish a network connection with a server having access to a user information database. The autofill device can execute instructions to load a form into memory, enter an autofill mode in response to an instruction received from a user, receive a permission token from the client device over the peer to peer connection, send a request for user data stored in the user information database to the server over the network connection along with the permission token, and receive the user data from the server upon verification of the permission token by the server. The autofill device can parse the user data and fill at least one form field in the form with parsed user data, before printing and/or electronically sending the filled-in form.

The present disclosure also provides a system comprising an autofill device, a server having access to a user information database and being configured to generate a permission token granting access to particular user data stored in the user information database, and client device in selective communication with the autofill device over a direct peer to peer connection. The autofill device can be configured to load a digital form into memory and enter an autofill mode in response to an instruction from a user. The client device can be configured to receive the permission token from the server and pass it to the autofill device. In autofill mode, the autofill device can pass the permission token to the server for verification, receive requested user data from the server if the permission token is verified. The autofill device can then parse the user data and use it to automatically fill in corresponding form fields in the form.

The present disclosure also provides a method of autofilling a form, comprising loading a form comprising a plurality of form fields into memory at an autofill device, entering an autofill mode at the autofill device in response to a user instruction, receiving a permission token at the autofill device from a client device over a direct peer to peer connection, sending a request for user data to a server from the autofill device over a network connection along with the permission token, receiving the user data from the server at the autofill device upon verification of the permission token by the server, and parsing the user data at the autofill device and filling in corresponding ones of the plurality of form fields with parsed user data.

### BRIEF DESCRIPTION OF THE DRAWINGS

FIG. 1 depicts a non-limiting example of a form.

FIG. 2 depicts a form autofilling system.

FIG. 3 depicts an embodiment of an autofill device.

FIG. 4 depicts an embodiment of a client device.

FIG. 5 depicts a process for at least partially autofilling form fields of a selected form using an autofill device.

FIG. 6 depicts an exemplary screen listing available forms on an autofill device.

FIG. 7 depicts a fillable field displayed on an autofill device corresponding to a form field.

FIGS. 8A-8D depict exemplary screens for displaying a preview of a filled-in form.

### DETAILED DESCRIPTION

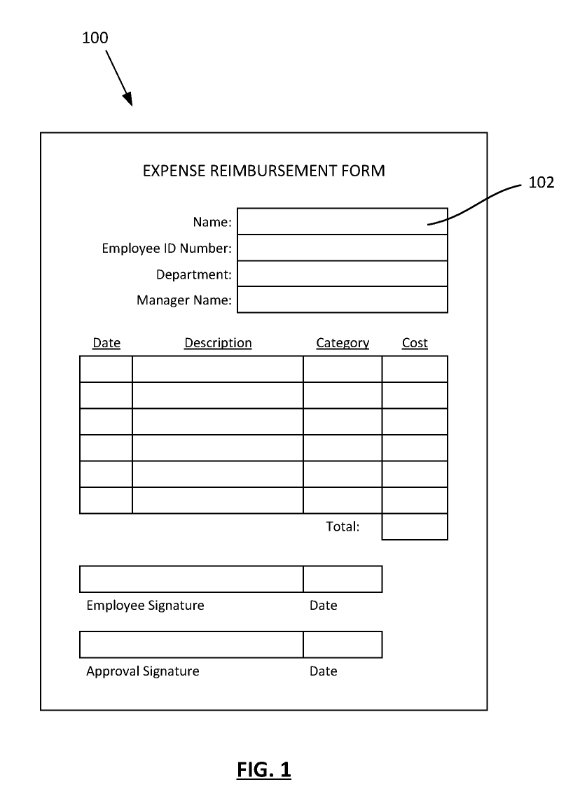

FIG. 1 depicts a non-limiting example of a form 100. A form 100 can be a digital document that can be digitally stored in memory in text and/or image data formats, and/or printed into a hard copy. By way of a non-limiting example, a form 100 can be a PDF document. A form 100 can be a document comprising text, images, and/or one or more form fields 102 that can be filled in with data. By way of non-limiting examples, forms 100 can be accounting forms, expense report forms, reimbursement forms, human resources forms, incident reporting forms, payroll forms, tax forms, insurance information forms, or any other type of form.

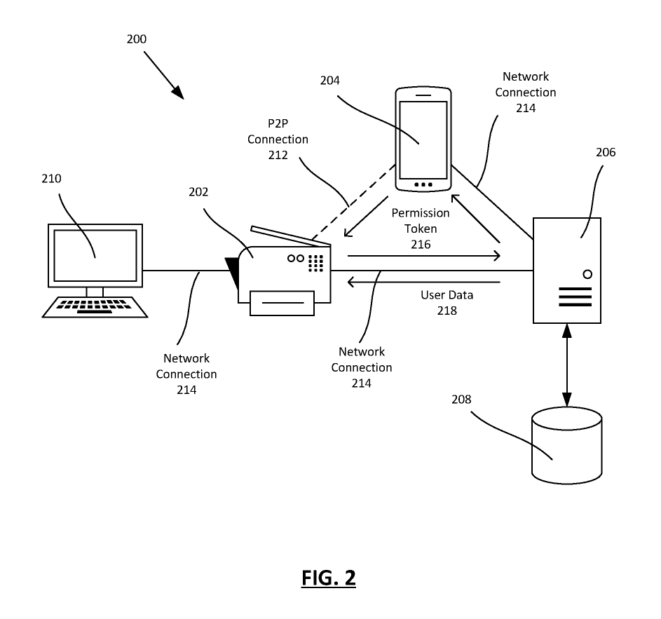

FIG. 2 depicts a form autofilling system 200. The form autofilling system 200 can comprise an autofill device 202, a client device 204, and a server 206. The server 206 can store, or be connected to, a user information database 208. In some embodiments, the autofill device 202 can also selectively communicate with a form editing device 210. The autofill device 202 can be configured to load a form 100 from memory, retrieve information from the user information database 208 via the server 206, and digitally fill associated form fields 102 in the loaded form 100. The autofill device 202 can then print the autofilled form 100, and/or electronically send the autofilled form 100 to a desired destination.

The autofill device 202 and the client device 204 can be directly connected at least temporarily via a direct P2P connection 212. The P2P connection 212 can be any network or connection that links the autofill device 202 directly with a client device 204, such that the linked devices can exchange data over the P2P connection 212 without routing the data through intermediate or centralized servers, or over other networks to which other components of the form autofilling system 200 are connected. In some embodiments, the P2P connection 212 can be a Near Field Communication (NFC) connection, through which the client device 204 can communicate directly with the autofill device 202 when it is physically proximate to the autofill device 202. In other embodiments, the P2P connection 212 can be any other type of direct wireless connection, such as a Bluetooth connection, a Wi-Fi Direct connection, a wireless ad hoc network, a Universal Plug and Play (UPnP) connection, and/or any other type of P2P connection.

Network connections 214 can link the autofill device 202 with the server 206, the client device 204 with the server 206, and the form editing device 210 with one or more other components of the form autofill system 200. In some embodiments and/or situations, a network connection 214 can be a connection made over a wide area network (WAN), such as the internet. In other embodiments and/or situations, a network connection 214 can be a connection made over a local area network (LAN), such as an internal office intranet. In still other embodiments and/or situations, a network connection 214 can include communications over both a WAN and LAN.

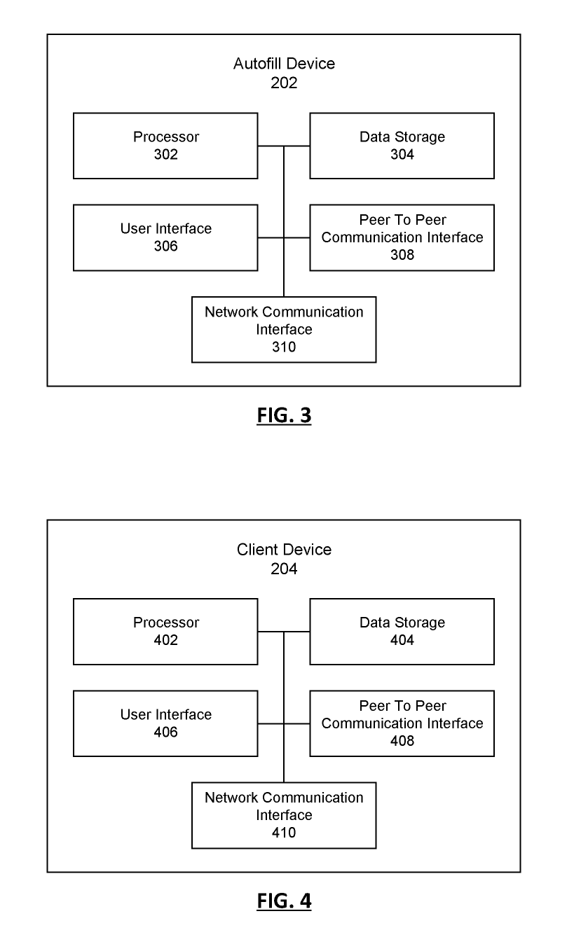

FIG. 3 depicts an embodiment of an autofill device 202. An autofill device 202 can comprise a processor 302, data storage 304, a user interface 306, a peer to peer (P2P) communication interface 308, and a network communication interface 310.

In some embodiments the autofill device 202 can be a printer, such as a standalone printer or an “all-in-one” multifunctional printer (MFP) that comprises a printer, scanner, copier, fax machine, and/or other components in a single device. In alternate embodiments the autofill device 202 can be a computer, tablet computer, smartphone, server, dedicated autofill device, or any other device. In some embodiments in which the autofill device 202 does not comprise a printer, the autofill device 202 can be temporarily or permanently connected to a separate printer via a wired or wireless connection.

The autofill device's processor 302 can be a chip, circuit or controller configured to execute instructions to direct the operations of the autofill device 202, such as a central processing unit (CPU), application-specific integrated circuit (ASIC), field-programmable gate array (FPGA), graphics processing unit (GPU), or any other chip, circuit, or controller. In some embodiments a plurality of chips, circuits, and/or controllers can operate together to direct the operations of the autofill device 202.

The autofill device's data storage 304 can be one or more internal and/or external digital storage devices, such as random access memory (RAM), read-only memory (ROM), electrically erasable programmable read-only memory (EEPROM), flash memory, digital tape, a hard disk drive (HDD), a solid state drive (SSD), any/or any other type of volatile or non-volatile digital memory. The data storage 304 can store instructions executable by the processor 302 to operate the autofill device 202, including an operating system and applications. The data storage 304 can also store data related to one or more forms 100 and/or autofilling forms 100, as will be discussed further below.

The autofill device's user interface 306 can comprise hardware and/or software elements for receiving instructions from users and/or displaying information to users. By way of various non-limiting examples, the autofill device's user interface 306 can comprise a screen and/or input devices, such as liquid-crystal display (LCD) screens, other electronic screens, touchscreens, buttons, keyboards, switches, dials, indicator lights, speakers, graphical user interfaces, and/or any other input or output device. In some embodiments external input or output devices can also be selectively coupled with the autofill device 306 through which the autofill device can receive input from users or provide output to users, such as a keyboard or mouse connected with a USB connection or any other connection, or an external monitor.

The autofill device's P2P communication interface 308 can be a networking device configured to communicate directly with a client device 204 over a P2P connection 212. By way of a non-limiting example, the autofill device's P2P communication interface 308 can be an NFC device that allows a client device 204 to communicate directly with the autofill device 202 when it is physically proximate to the autofill device 202. By way of other non-limiting examples, the autofill device's P2P communication interface 308 can be a Bluetooth interface, a Wi-Fi Direct interface, or any other interface configured to communicate directly with a client device 204 over a P2P connection 212.

The autofill device's network communication interface 310 can be a networking device configured to communicate with the server 206 and/or the form editing device 210 over a wired or wireless network connection 214, such as a Wi-Fi or Ethernet connection interface. By way of a non-limiting example, when the server 206 is a remote cloud server, the autofill device 202 can communicate with the server 206 over the internet.

In some embodiments, such as when the autofill device 202 is a printer or MFP, the autofill device 202 can further comprise one or more of: a printer component, a scanner component, a fax machine component, and/or a data storage connection port. The printer component can be a black and white and/or color printer, such as a laser printer or inkjet printer that is configured to print text and/or images onto paper from a paper tray in the autofill device 202. In some embodiments the printer component can further comprise a finisher and/or one or more paper cassettes. The scanner component can be a black and white and/or color scanner configured to scan text and/or images on documents that are either placed on a scanner bed or platen in the autofill device 202, or are placed in a document feeder in the autofill device 202 such that the scanner sequentially pulls and scans individual pages from the document feeder. The fax machine component can be configured to scan documents with the scanner component or with a separate dedicated fax scanner in the autofill device 202. Documents scanned into autofill device 202 or received digitally from another source can be faxed to another fax machine via a fax connection over a telephone line connected to the autofill device 202, or over the internet or other network connection 214. The data storage connection port can be a physical connector configured to selectively accept a removable digital storage device, such as a USB flash drive, external hard disk drive, memory card, or any other removable data storage device. The autofill device 202 can be configured to exchange data with a data storage device connected to the data storage connection port.

FIG. 4 depicts an embodiment of a client device 204. A client device 204 can be a portable computing device such as a smartphone, tablet computer, laptop computer, smartwatch, or any other portable computing device. The client device 204 can run an application and/or operating system that is configured to communicate with the autofill device 202 and/or the server 206. The client device 204 can comprise a processor 402, data storage 404, a user interface 406, a peer to peer (P2P) communication interface 408, and a network communication interface 410.

The client device's processor 402 can be a chip, circuit or controller configured to execute instructions to direct the operations of the client device 204, such as a central processing unit (CPU), application-specific integrated circuit (ASIC), field-programmable gate array (FPGA), graphics processing unit (GPU), or any other chip, circuit, or controller. In some embodiments a plurality of chips, circuits, and/or controllers can operate together to direct the operations of the client device 204.

The client device's data storage 404 can be one or more internal and/or external digital storage devices, such as random access memory (RAM), read-only memory (ROM), electrically erasable programmable read-only memory (EEPROM), flash memory, digital tape, a hard disk drive (HDD), a solid state drive (SSD), any/or any other type of volatile or non-volatile digital memory. The data storage 404 can store instructions executable by the processor 402 to operate the client device 204, including an operating system and applications. The data storage 304 can also store data related to one or more forms 100 and/or autofilling forms 100, as will be discussed further below.

The client device's user interface 406 can comprise hardware and/or software elements for receiving instructions from users and/or displaying information to users. By way of various non-limiting examples, the client device's user interface 406 can comprise a screen and/or input devices, such as liquid-crystal display (LCD) screens, other electronic screens, touchscreens, buttons, keyboards, switches, dials, indicator lights, speakers, graphical user interfaces, and/or any other input or output device.

The client device's P2P communication interface 408 can be a networking device configured to communicate directly with the autofill device 202 over a P2P connection 212. By way of a non-limiting example, the client device's P2P communication interface 408 can be an NFC device that allows the client device 204 to communicate directly with the autofill device 202 when it is physically proximate to the autofill device 202. By way of other non-limiting examples, the client device's P2P communication interface 408 can be a Bluetooth interface, a Wi-Fi Direct interface, or any other interface configured to communicate directly with the autofill device 202 over a P2P connection 212.

The client device's network communication interface 310 can be a networking device configured to communicate with the server 206 over the internet or other network connection 214. By way of a non-limiting example, the client device's network communication interface 310 can comprise a cellular data connection interface and/or Wi-Fi connection interface, such that the client device can send and receive data over the internet wirelessly.

Returning to FIG. 2, the server 206 can be a computer or device through which information in the user information database 208 can be accessed. The server 206 can comprise processors, memory, circuits, and/or other hardware and software elements, as well as a network communication interface through which it can communicate with the autofill device 202 and/or the form editing device 210 over a network connection 214, such as over an internet or Ethernet connection. In some embodiments the server 206 can be remote from the autofill device 202, such as a remote cloud server, and the autofill device 202 can communicate with the remote server 206 over an internet connection. In other embodiment the server 206 and autofill device 202 can be proximate to each other and/or be connected to the same local network. By way of a non-limiting example, in some embodiments the server 206 and autofill device 202 can be connected to a shared office intranet.

The server 206 can be programmed to read and/or write data to the user information database 208, and/or search for and retrieve information from the user information database 208. In some embodiments the server 206 can store the user information database 208 in one or more its own internal digital storage devices, such as a hard disk drive. In alternate embodiments the server 206 can be linked to a separate computer, disk drive, or other data storage component upon which the user information database 208 is stored.

The user information database 208 can be configured to store information about users of client devices 204 in one or more data fields in a database. By way of a non-limiting example, users of the client devices 204 can be employees of a company that owns or operates the autofill device 202, server 206, and/or user information database 208, and the user information database 208 can store information about the employees such as their names, birthdates, employee identification numbers, social security numbers, hiring dates, review dates, department identification numbers, or any other type of information.

The server 206 can also be configured to generate permission tokens 216. A permission token 216 can be a data element that grants a device access to specific user data 218 stored in the user information database 208, such as information related to a particular employee or other user. In some embodiments, the permission token 216 can further indicate the address, such as an IP address of the server 206, such that a device holding the permission token 216 can access the server 206.

Upon a request from a client device 204, the server 206 can generate a permission token 216 that grants access to user data 218 associated with the owner or holder of that client device 204, and send that permission token 216 to the requesting client device 204. If and when that client device 204 transfers the permission token 216 to another device, such as an autofill device 202, the device holding the permission token 216 can use it to access the associated user data 218 through the server 206.

The permission token 216 can be a single-use token, such that once any device sends the permission token back to the server 206 to access data in the user information database 208, the permission token 216 becomes invalid in the server's records such that it cannot be used again the same device, or any other device, to access the associated user data 218 from the user information database 208.

The server 206 can maintain a list of issued and valid permission tokens 216, such that they can later be recognized and verified by the server 206. In some embodiments, if a device submits a valid permission token 216 to the server 206, the permission token 216 can be marked as invalid in the server's records, such that the same permission token 216 cannot be used more than once. In some embodiments the permission token 216 can additionally have an expiration date or duration, such that the permission token 216 expires and becomes invalid after a set period of time.

The form editing device 210 can be a computing device such as a desktop computer, laptop computer, tablet computer, smartphone, mobile device, or any other device. The form editing device 210 can comprise processors, memory, circuits, and/or other hardware and software elements, as well as a network communication interface through which it can communicate with the autofill device 202 and/or the server 206 over a network connection 214, such as over an internet or Ethernet connection.

The form editing device 210 can be configured to allow users to generate and/or edit forms 100. A user can use software on the form editing device 210 to create a new form 100 and/or edit an existing form 100. In some embodiments, new or edited forms 100 can be sent over a network connection 214 from the form editing device 210 to the autofill device 202, to be stored within a directory or other memory location in the autofill device's data storage 304. In other embodiments, new or edited forms 100 can be stored in memory on the form editing device 210 but be accessible by the autofill device 202 over a network connection 214. In still other embodiments, forms 100 created or edited on the form editing device 210 can be sent to and stored on the server 206, or in any other location accessible by the autofill device 202 over a network connection 214.

In some embodiments or situations a client device 204 can be configured to act as a form editing device 210. By way of a non-limiting example, a client device 204 can be a smartphone or laptop computer capable of generating and/or editing forms 100 digitally, and uploading them to the autofill device 202. In other embodiments the form editing device 210 can be a separate device.

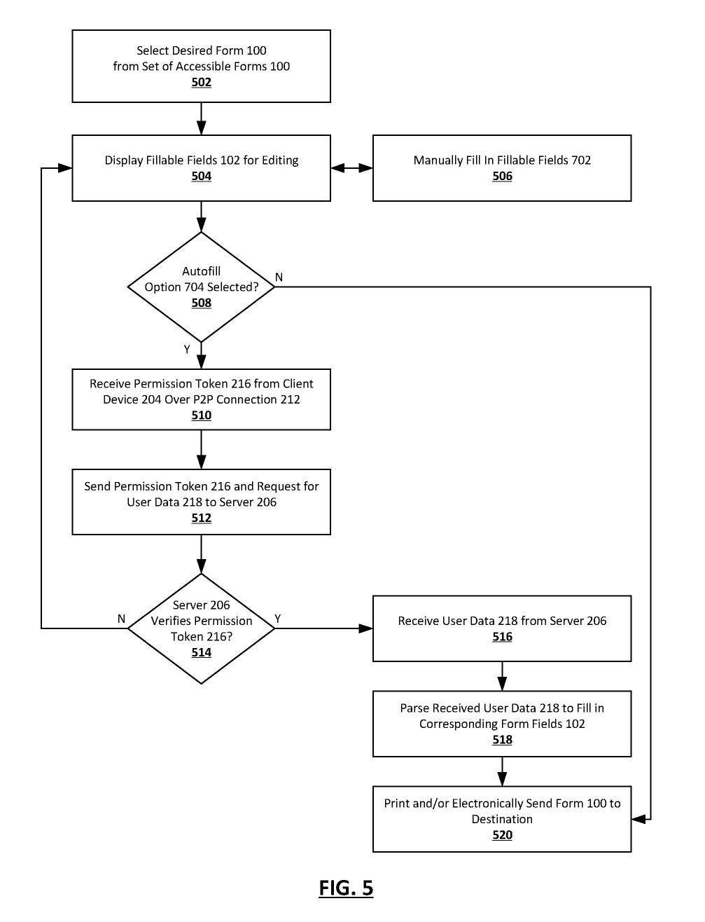

FIG. 5 depicts a process for at least partially autofilling form fields 102 of a selected form 100 using an autofill device 202. In some embodiments the process of FIG. 5 can be initialized when a user selects a form filling option on the autofill device 202. By way of a non-limiting example, if the autofill device 202 is a MFP, a user can initiate the process of FIG. 5 by selecting a form filling option on the MFP's user interface 306 instead of selecting other options for copying, printing, scanning, or faxing.

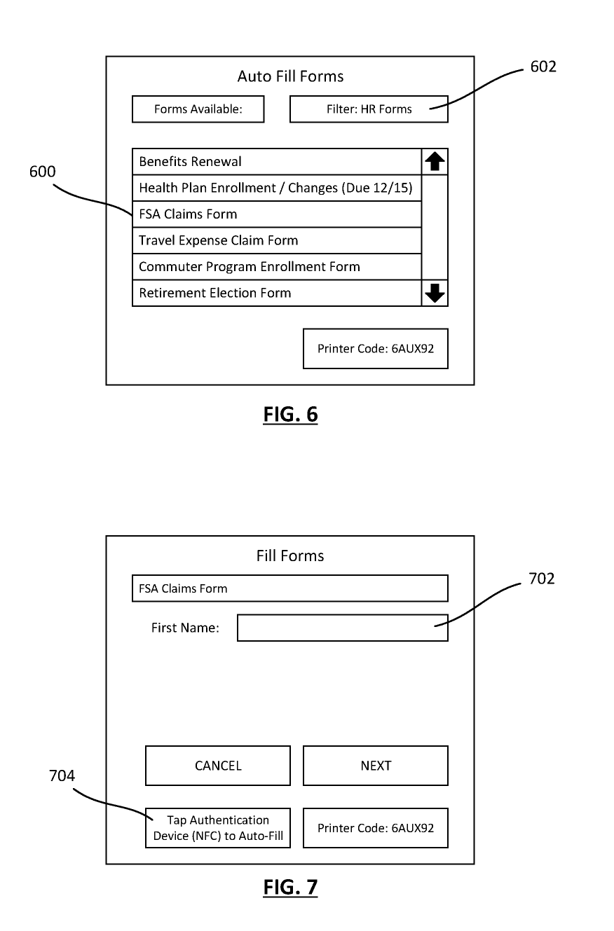

In other embodiments a direct P2P connection 212 can be established between the autofill device 202 and a client device 204 before beginning the steps of FIG. 5 with either the autofill device 202 or the client device 204. By way of a non-limiting example, a user can select an option on the autofill device 202 and/or a client device 204 to establish the P2P connection 212 between the devices, or to enter a pairing mode in which a P2P connection 212 can be established if the devices are proximate to each other and/or recognize each other. In some embodiments, the autofill device 202 can display and/or be associated with a unique identifier, such that a user of the client device 204 can use the unique identifier to ensure they are connecting to the correct autofill device 202. By way of a non-limiting example, when the autofill device 202 is a printer and there may be many printers in the same office, the printer can display a printer number as shown in FIG. 6, such that users can indicate that they want to connect their client device 204 to the printer with that printer number. In some embodiments, a message can be displayed with the autofill device 202 and/or client device 204 that indicates that a P2P connection 212 has been successfully established between the devices.

At step 502, a user can select a form 100 from a set of one or more available forms 100 that are accessible by the autofill device 202. One or more forms 100 can have been previously generated and/or edited with form editing devices 210, and then stored in the autofill device's data storage 304 or at another digital storage location accessible by the autofill device 202.

In some embodiments, the user can select a desired form 100 with the autofill device's user interface 306. In other embodiments the user can use a client device 204 to select a desired form 100 to load at the autofill device 202, if the client device 204 has already been connected to the autofill device 202 with a direct P2P connection 212. In these embodiments the autofill device 202 can transfer identities of available forms 100 to the client device 204 such that the user can select one using the client device's user interface 406.

The autofill device 202 or client device 204 can display a list, thumbnail image grid, or other representation of the forms 100 available through the autofill device 202 on its screen, such that a user can navigate through the available forms 100 and select one through the autofill device's user interface 306 or client device's user interface 406. By way of a non-limiting example, FIG. 6 depicts an exemplary list 600 of available forms 100 displayed on an autofill device's screen. In some embodiments, a user can use the user interface 306 or client device 204 to filter or search available forms 100 by type, category, department, name, due date, requestor, author, creation date, expiration date, or any other attribute. By way of a non-limiting example, the exemplary display shown in FIG. 6 includes a filter option 602 that allows users to filter the list 600 of available forms 100.

A user can use the autofill device's user interface 306 or client device's user interface 406 to select one of the available forms 100. When the user selects a form 100, the autofill device 202 can open and/or load a copy of the selected form 100 into memory such that its form fields 102 can be filled in with data as described below.

In some embodiments step 502 can be skipped or modified if only a single form 100 is available to the autofill device 202. In these embodiments the single form 100 can be automatically loaded into the autofill device's memory to be filled in upon receipt of an instruction by a user, without selecting the form 100 from a list 600 or other representation of available forms 100.

At step 504, once a copy of the selected form 100 has been selected and loaded into memory at the autofill device 202 such that its form fields 102 can be filled in, representations of each form field 102 in the form can be displayed on a screen at the autofill device 202, and/or on the client device's screen. By way of a non-limiting example, FIG. 7 depicts an exemplary display on the autofill device's screen that indicates the identity of the selected form 100 and a fillable field 702 corresponding to one of the form fields 102 in the form 100.

During step 506, users can use the autofill device's user interface 306 or the client device's user interface 406 to manually fill in any number of fillable fields 702. By way of a non-limiting example, in the embodiment of FIG. 7 a user can use the autofill device's user interface 306 or an external keyboard to fill in one fillable field 702, before selecting a “NEXT” button to move to another fillable field 702 corresponding to another form field 102 in the form 100.

While displaying representations of form fields 102, the autofill device 202 and/or client device 204 can display an autofill option 704. If during step 508 the autofill device 202 determines that the autofill option 704 has not yet been selected, the user can continue manually entering data into the fillable fields at step 506 or, if the user indicates they have completed entering data, the autofill device 202 can move directly to step 520 to print and/or electronically send the filled form 100 to a desired destination. However, if the autofill device 202 determines that the autofill option 704 has been selected during step 508, the autofill device 202 can move to step 510.

If the client device 704 has not yet established a direct P2P connection 212 with the autofill device prior to step 510, a P2P connection 212 can be established when the autofill option 704 is selected, or the devices can enter a pairing mode in which a P2P connection 212 can be made if the devices are proximate to each other and/or recognize each other. By way of a non-limiting example, FIG. 7 depicts an exemplary display on the autofill device's screen that includes an autofill option 704 that allows users to indicate that they desire to link their client device 204 to the autofill device 202 using an NFC connection when the client device 204 is tapped on or near the autofill device 202, such as at a designated location on the autofill device's exterior.

At step 510, once a user has selected an autofill option 704 and the autofill device 202 has been linked with a client device 204 directly with a P2P connection 212, the client device 204 can transfer a permission token 216 to the autofill device 202 over the direct P2P connection 212. In some situations or embodiments, the client device 204 can have previously obtained a single use permission token 216 from the server 206 over a network connection 214. In other situations or embodiments, the client device 204 can request and receive a single use permission token 216 from the server 206 over a network connection 214 when the user selects a desired form 100, when the user selects an autofill option 704, and/or when a new P2P connection 212 is made between the client device 204 and the autofill device 202. The permission token 216 received by the autofill device 202 during step 510 can grant the autofill device 202 with access to user data 218 in the user information database 208 related to a particular user or user account, such as the owner of the client device 204 or a user who is logged in to the client device 204.

At step 512, after the autofill device 202 has received a permission token 216 from the client device, the autofill device 202 can submit a request for user data 218 to the server 206. The autofill device 202 send the permission token 216 to the server 206 as part of the request. In some embodiments or situations the autofill device 202 can request particular pieces of user data 218 that correspond to form fields 102 in the selected form. In other embodiments or situations the autofill device 202 can request all user data 218 associated with the permission token 216, such that the autofill device 202 can later parse the user data 218 when determining which data to use when filling in form fields 102.

At step 514, the server 206 can consult its records to attempt to verify the permission token 216 sent by the autofill device 202. If the server 206 determines that it did not issue the permission token 216, that the permission token 216 has already been used to obtain user data 218, and/or that the permission token 216 has expired, the server 206 can reject the permission token 216 as invalid and refuse the autofill device's request for user data 218. In some embodiments or situations, the autofill device 202 can return to step 504 if its request is rejected by the server 206 such that the user can continue entering information manually. However, if the server 206 determines that the permission token 216 was issued by the server 206, that it has not yet been used, and that it has not yet expired, the server 206 can determine that the permission token 216 is valid.

During step 516, if the server 206 verifies the permission token 216, the server 206 can send the requested user data 218 to the autofill device 202. In some embodiments, once the server 206 determines that the permission token 216 is valid, the server 206 can immediately retrieve the requested user data 218 from the user information database 208 and send it to the autofill device 202. In other embodiments, after determining that the permission token 216 is valid, the server 206 can communicate with the client device 204 over a network connection 214 to verify that the client device 204 provided the permission token 216 to the autofill device 202 and that the client device 204 intended to grant the autofill device 202 access to the user data 218. If the client device 204 responds that it did not intend to give the autofill device 202 access to the user data 218, the server 206 can refuse the autofill device's request for user data 218. However, if the client device 204 responds that it did intend to give the autofill device 202 access to the user data 218, the server 206 can send the requested user data 218 to the autofill device 202.

During step 516, the server 206 can send the requested user data 218 in a format that can be read and/or parsed by the autofill device 202. By way of a non-limiting example, the server 206 can send requested user data 218 as a JSON (JavaScript Object Notation) object that the autofill device 202 can parse to read specific types of data.

After sending user data 218 to the autofill device 202, the server 206 can mark the permission token 216 as invalid in its records, such that the permission token 216 cannot be used again by the autofill device 202, the client device 204, or any other device to obtain user data 218. If the client devices 204 intends to grant access to their user data 218, the client device 204 can request another single-use permission token 216 from the server 206.

At step 518, the autofill device 202 can use the user data 218 to automatically fill in at least some form fields 102 in the selected form 100. By way of a non-limiting example, the autofill device 202 can parse the received user data 218 to find the user's name, employee identification number, department name, office location, and the name of their supervisor, and use that information to automatically fill in corresponding form fields 102 in the selected form 100. While in some embodiments the autofill device 202 can immediately fill in one or more form fields 102 with the received user data 218, in other embodiments the autofill device 202 can display the retrieved user data 218 to the user on a screen with the autofill device 202 or client device 204 prior to filling in any form fields 102, such that the user can edit it to make any corrections or updates to the retrieved information before it is used to fill in form fields 102.

If any form fields 102 were not automatically filled in with the received user data 218 during step 512, the autofill device 202 can prompt the user to fill in any remaining form fields 102 with new information using the autofill device's user interface 306 or the client device's user interface 406, such as by temporarily returning to steps 504 and 506. By way of a non-limiting example, the autofill device 202 can automatically fill in form fields 102 in an expense reimbursement form 100 with user data 218 that indicates the user's identity and employment information, but ask the user to input specific dollar values and items for which the user is requesting reimbursement.

In some embodiments, while the autofill device 202 is requesting user data 218 from the server 206, and parsing received user data 218 to automatically fill in form fields 102 during steps 512 through 518, the autofill device 202 and/or client device 204 can display messages on their screens indicating that the autofill process is currently being executed.

At step 520, after filling in some or all of the form fields 102 automatically and/or with user input, the autofill device 202 can print and/or electronically send the form 100 to a desired destination.

When the form 100 indicates that it should be printed, and/or a user indicates that they want to print the form 100, the autofill device 202 can print the form 100. In some embodiments the autofill device 202 can be or comprise a printer that can print the filled-in form 100, while in other embodiments the autofill device 202 can be at least temporarily connected to a printer to print the filled-in form 100. In some embodiments, the user can use the autofill device 202 or client device 204 to change any print settings, such as changing the paper size or print quality, before printing the filled-in form 100.

When the form 100 indicates that it should be electronically sent to a destination, and/or a user indicates that they want to electronically send the form 100 to a destination, the autofill device 202 can electronically sent the form to the desired destination. The destination can be the form editing device 210 that created the form 100, the server 206, an email address, a directory or folder on a specified computer or server, a removable memory storage device, or any other digital destination. By way of non-limiting examples, a copy of a filled-in form 100 can be sent to a supervisor's email address, or to an inbox folder for a particular department. In some embodiments the form 100 itself can indicate its destination, while in other embodiments the destination can be indicated by the user and/or by retrieved user data 218. By way of a non-limiting example, a form 100 can indicate that it should be sent to a user's supervisor, and the retrieved user data 218 can indicate the identity of the supervisor for a particular user such that the autofill device 202 can send the filled form 100 to that supervisor's email address or a server directory associated with the supervisor.

In some embodiments a preview of the filled-in form 100 can be displayed to the user on a screen with the autofill device 202 or client device 204 before it is printed and/or electronically sent to a specified destination. In these embodiments, the user can either confirm that they want to print and/or send the filled-in form 100, or use the autofill device's user interface 306 or the client device's user interface 406 to edit information in the filled-in form 100. If the user makes any edits, a revised preview of the filled-in form 100 can be displayed to users on the screen of the autofill device 202 or client device 204, so that the user can again confirm that they want to print and/or send the filled-in form 100 or make further edits.

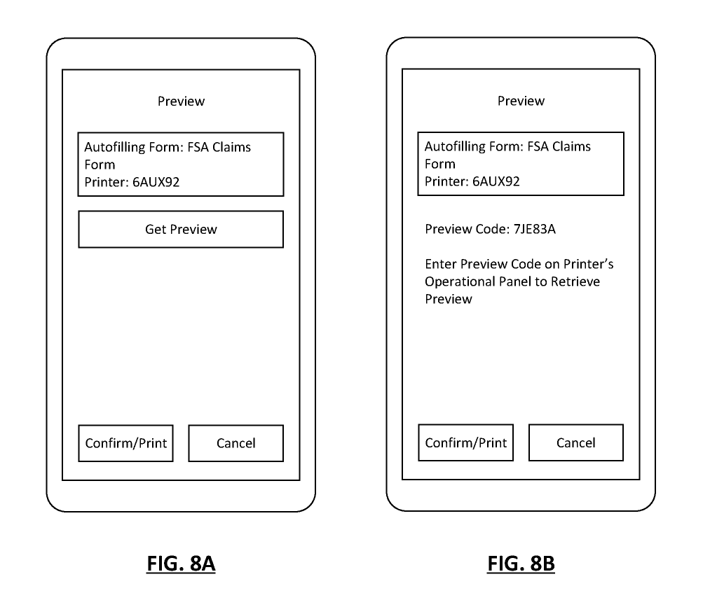

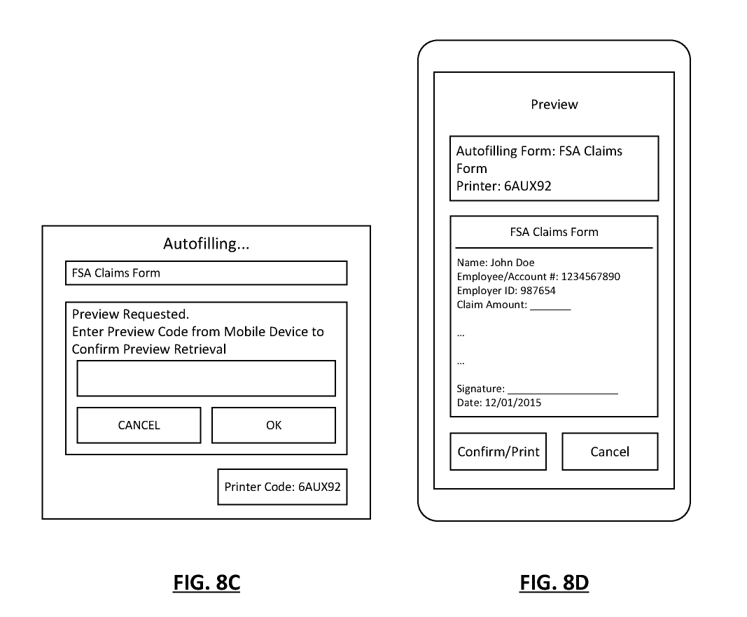

In some embodiments, the autofill device 202 and/or client device 204 can be configured to protect access to a preview of the filled-in form 100 unless a user enters a code displayed on the client device 204 at the autofill device 202 By way of a non-limiting example, FIG. 8A depicts an exemplary screen on the client device 204 wherein a user can select an option to view a preview of the filled-in form 100 before printing it. If the user selects the preview option, a preview code can be displayed on the client device 204 as shown in FIG. 8B, and a field can be displayed on the autofill device 202 into which the user can enter the preview code, as shown in FIG. 8C. If the user enters the correct preview code, a copy of the filled-in form 100 can be displayed as a preview on the client device 204, as shown in FIG. 8D.

In some embodiments, if the form 100 has a form field 102 for a user's signature or other information that a user desires to enter by hand, the autofill device 202 can print the filled-in form 100 using an integrated or connected printer. The user can hand-write their signature on the printed version of the form 100. In some situations, the user can then hand-deliver the signed hard copy to its destination. In other situations, the user can scan the signed hard-copy back into the autofill device 202. By way of a non-limiting example, when the autofill device is an MFP, the MFP can print the filled-in form 100 as a hard copy and then use its scanner to scan the hard copy after it has been signed by the user. The scanned signed copy of the form 100 can then be electronically sent to a desired destination.

In other embodiments, if the form 100 has a form field 102 for a user's signature or other information that a user desires to enter by hand, the user can use a finger, electronic pen, or other input device to input the signature or information using the client device's user interface 406 or autofill device's user interface 306, before printing and/or sending the form 100 to a destination. By way of a non-limiting example, in some embodiments a user can use their finger or a stylus to sign a preview of the form 100 on their client device 204, as shown in FIG. 8D. In still other embodiments, the user can use a digital image of their signature stored at the client device 204 or server 206 to insert their signature into the form 100 before printing and/or sending the form 100 to a destination.

In some embodiments, when a filled-in form 100 is electronically sent to a destination, the receiving device can send a confirmation message back to the autofill device 202 and/or client device 204 indicating the form 100 was successfully received. In some embodiments the confirmation message can indicate the identity of the destination, such that the user can maintain a record of where the form 100 was deposited. By way of a non-limiting example, the confirmation message can indicate that the form 100 was saved to a particular directory or database, such that the user can later retrieve it from that directory or database if necessary.

In some embodiments the autofill device 202 can discard the permission token 216 and/or received user data 218 after the filled-in form 100 is printed and/or electronically sent to a destination. By way of a non-limiting example, the autofill device 202 can discard the permission token 216 and/or received user data 218 upon receipt of a confirmation message indicating that the form 100 was received at its destination. In alternate embodiments the user can specify an expiration date for the user data 218 at the autofill device 202, such that the user data 218 can be re-used for additional forms 100 until it expires and the data is deleted from the autofill device 202. By way of a non-limiting example, a user can specify that his or her user data 218 can remain on the autofill device 202 for 10 days, or until the due date of a particular form 100, such that the user can re-use it to autofill additional forms 100 until the user data 218 expires and a new permission token 216 would need to be issued to obtain it again. Similarly, in some embodiments a copy of a filled-in form 100 can be saved in memory at the autofill device 202 for a limited or unlimited period of time, such that it can be loaded to print another copy or to electronically send it to another destination.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. An autofill device, comprising:
a peer to peer networking interface configured to establish a direct peer to peer connection with a client device;
a network interface configured to establish a network connection with a server having access to a user information database; and
a non-transitory machine-readable medium having instructions recorded thereon for causing the autofill device to perform the steps of:
loading a form into memory, the form comprising a plurality of form fields;
entering an autofill mode in response to an instruction received from a user;
receiving a permission token from the client device over the peer to peer connection;
sending a request for user data stored in the user information database to the server over the network connection along with the permission token;
receiving the user data from the server upon verification of the permission token by the server; and
parsing the user data and filling at least one of the plurality of form fields with parsed user data.

2. The autofill device of claim 1, further comprising a printer component.

3. The autofill device of claim 2, wherein the instructions further cause the autofill device to print the form with the printer component after filling at least one of the plurality of form fields with parsed user data.

4. The autofill device of claim 3, wherein the instructions further cause the autofill device to display a print preview of the form prior to printing, and to print the form with the printer component when a confirmation instruction is received from a user.

5. The autofill device of claim 1, wherein the instructions further cause the autofill device to electronically send the form to a destination after filling at least one of the plurality of form fields with parsed user data.

6. The autofill device of claim 5, wherein the instructions further cause the autofill device to display a preview of the form prior to electronically sending it to the destination, and to electronically send it to the destination when a confirmation instruction is received from a user.

7. The autofill device of claim 1, wherein the permission token is a single use token that becomes invalid after the server verifies the permission token and the user data is received.

8. A system comprising:
an autofill device configured to load into memory a digital form comprising one or more form fields and enter an autofill mode in response to an instruction from a user;
a server in selective communication with the autofill device over a network connection, the server having access to a user information database and being configured to generate a permission token granting access to particular user data stored in the user information database; and
a client device in selective communication with the autofill device over a direct peer to peer connection and in selective communication with the server over a network connection, the client device being configured to receive the permission token from the server,
wherein when autofill device enters the autofill mode, the client device is configured to pass the permission token to the autofill device, the autofill device is configured to pass the permission token to the server for verification, and the server is configured to send the particular user data to the autofill device if the permission token is verified by the server, and
wherein the autofill device is configured to parse the particular user data and use it to automatically fill in corresponding ones of the one or more form fields.

9. The system of claim 8, wherein the autofill device is further configured to print the form after automatically filling in one or more form fields with parsed user data.

10. The system of claim 9, wherein the autofill device displays a print preview prior to printing the form.

11. The system of claim 8, wherein the autofill device is further configured to electronically send the form to a destination after automatically filling in one or more form fields with parsed user data.

12. The system of claim 11, wherein the autofill device displays a preview of the form prior to electronically sending the form.

13. The system of claim 8, wherein the permission token is a single use token that becomes invalid after the server verifies the permission token and sends the particular user data to the autofill device.

14. The system of claim 8, wherein the autofill device comprises a printer.

15. A method of autofilling a form, comprising:
loading a form comprising a plurality of form fields into memory at an autofill device;
entering an autofill mode at the autofill device in response to a user instruction;
receiving a permission token at the autofill device from a client device over a direct peer to peer connection;
sending a request for user data to a server from the autofill device over a network connection along with the permission token;
receiving the user data from the server at the autofill device upon verification of the permission token by the server; and
parsing the user data at the autofill device and filling in corresponding ones of the plurality of form fields with parsed user data.

16. The method of claim 15, further comprising printing the form after filling in form fields with parsed user data.

17. The method of claim 16, further comprising displaying a preview of the form prior to the printing, and performing the printing upon receipt of a confirmation instruction from a user.

18. The method of claim 15, further comprising electronically sending the form to a destination after filling in form fields with parsed user data.

19. The method of claim 16, further comprising displaying a preview of the form prior to electronically sending the form, and electronically sending the form upon receipt of a confirmation instruction from a user.

20. The method of claim 15, wherein the permission token is a single use token that becomes invalid after the server verifies the permission token and the user data is received.
